(19) United States
(12) Patent Application Publication
(10) Pub. No.: US 2005/0268483 A1
(43) Pub. Date: Dec. 8, 2005

(54) Dryer and lamp cover mounting structure for dryer

(75) Inventors: Young Hwan Park, Seoul (KR); Soo Won Park, Sacheon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/133,248

(22) Filed: May 20, 2005

(30) Foreign Application Priority Data
May 20, 2004 (KR) 35799/2004

(51) Int. Cl. F26B 3/34; F26B 11/02

(52) U.S. Cl. 34/603

(57) ABSTRACT

A dryer and a lamp cover mounting structure for a dryer is provided. The dryer includes a drying drum, a supporting member for supporting the front portion of the drying drum, a lamp cover installed on the rear portion of the supporting member, and a mounting portion at the rear of the supporting member for mounting the lamp cover thereon.

### BACKGROUND OF THE INVENTION

1. Field of the Invention

The present invention relates to a dryer, aand more particularly, to a dryer having a lamp cover mount for protecting a lamp that illuminates the inside of a drying chamber of a dryer when wet laundry is put into or dried laundry is taken out of the drying chamber.

2. Description of the Related Art

Dryers are generally used to completely dry the moisture remaining in laundry that has undergone a wash and spin cycle in a washing machine. Dryers are broadly divided into two categories: condenser-type dryers that circulate the air inside their drums through condenser and heater units and back into the drum, so that the air inside the drum is not expelled outside of the dryer, and exhaust-type dryers that routes air inside the drum through a condenser for de-humidification and then out from the dryer.

More specifically, in the case of condenser-type dryers, the air that circulates inside the dryer first absorbs moisture from laundry inside the drum, and then passes through the condenser, where the air is cooled through a heat exchange process. The moisture in the air is condensed as the air temperature cools. Finally, the condensed moisture is expelled from the dryer by means of a condenser pump.

In an exhaust-type dryer, on the other hand, hot air absorbs the moisture from laundry inside the drum, passes through a lint filter, and is expelled to the outside.

A lamp is required to illuminate the inside of the drum when the door is opened during a drying cycle or at the end of a drying cycle to extract laundry. Such a lamp, however, when exposed to the interior conditions of a drying drum, can crack due to the laundry tumbled inside the drum, and can be subject to an electrical malfunction due to the moisture inside the drum.

Accordingly, a device is needed to protect a lamp from the interior conditions of a drying drum.

### SUMMARY OF THE INVENTION

Accordingly, the present invention is directed to a dryer and a lamp cover mounting structure for a dryer that substantially obviates one or more problems due to limitations and disadvantages of the related art.

An object of the present invention is to provide a dryer lamp cover mount, for solidly fixing a lamp to the inside of a dryer so that the lamp is not damaged by laundry tumbled inside a drum of the dryer and for preventing moisture from the laundry from entering the lamp cover.

Another object of the present invention is to provide a dryer lamp cover mount, having an appropriate light intensity so as not to cause strain on a user's eyes while providing adequate illumination to the inside of a drying chamber when laundry is put in or taken out of the chamber.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a dryer lamp cover mounting structure including: a drying drum; a supporting member for supporting the front portion of the drying drum; a lamp cover installed at the rear of the supporting member; and a lamp cover mount for mounting the lamp cover to the rear of the supporting member.

In another aspect of the present invention, there is provided a dryer lamp cover mounting structure including a lamp cover, a cover plate, and a front cover. The lamp cover has a lamp cover dome located at the front of the dryer drum for receiving a lamp, a flange radially extending from the base of the lamp cover dome, a cylindrical sleeve extending from the inner circumference of the lamp cover dome, and a catch formed on the outer circumference of the sleeve. The cover plate has a lamp cover mount at its rear for mounting the lamp cover thereon and recessed at a predetermined distance to secure the extension, a lamp receptacle formed through the lamp cover mount for the sleeve to fit into, and a catch receptacle formed on the mount to form a secure fit with the catch. The front cover is installed on the front of the cover plate, and supports the front portion of the drying drum.

In a further aspect of the present invention, there is provided a dryer including a drying drum; a front cover supporting the front portion of the drying drum; a cover plate installed at the rear portion of the front cover; a lamp cover installed on one side of the cover plate and having a fastening catch formed on its outer circumference for securely fastening the lamp cover to the cover plate; and a lamp received in the lamp cover.

In the above embodiment of the present invention, the dryer lamp will not be damaged by laundry tumbling inside the drying chamber of the dryer.

Also, a lamp cover of the present invention will illuminate the inside of the drying chamber at an appropriate brightness level that will not strain a user's eyes.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a dryer with a lamp cover mount according to an embodiment of the present invention;

FIG. 2 is a cross-sectional view of the dryer of FIG. 1;

FIG. 3 is a perspective view of the inside of section C in FIG. 1;

FIG. 4 is a perspective view of a lamp cover according to an embodiment of the present invention;

FIG. 5 is an enlarged frontal perspective view of a cover plate on which the mount for the lamp cover is formed according to an embodiment of the present invention; and

FIG. 6 is an enlarged rear perspective view of the cover plate in FIG. 5.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

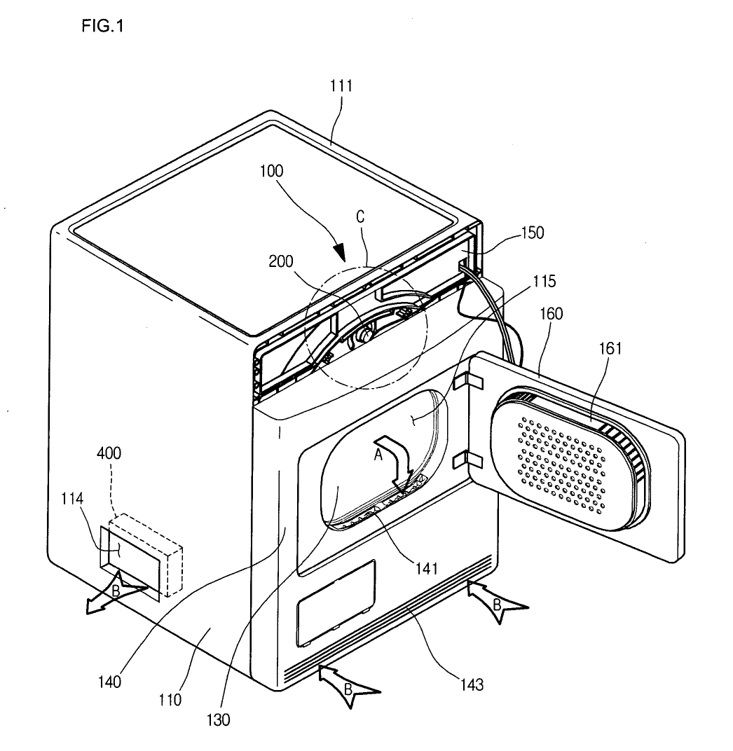

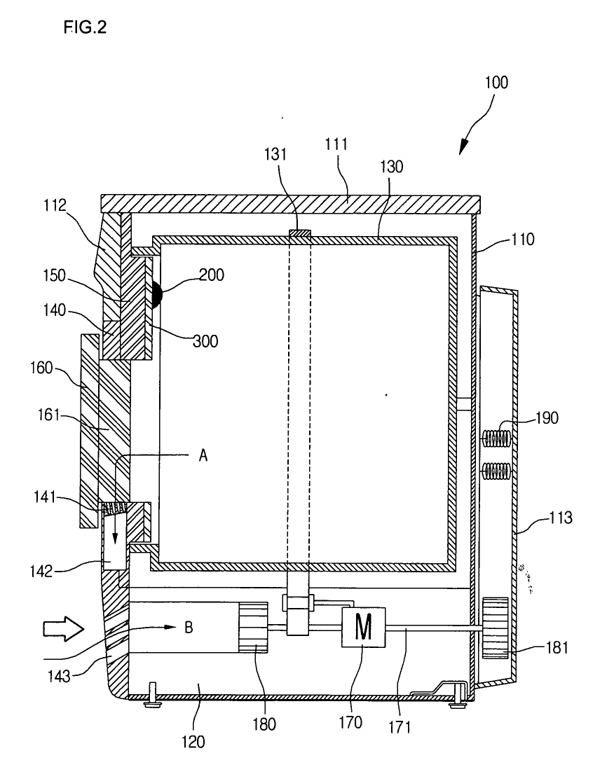

FIG. 1 is a perspective view of a dryer with a lamp cover mount according to an embodiment of the present invention, and FIG. 2 is a cross-sectional view of the dryer of FIG. 1.

Referring to FIGS. 1 and 2, the dryer 100 having the lamp cover mount of the present invention includes: a cabinet 110 constituting its outer portion; a top cover 111 covering the upper portion of the cabinet 110; a drying drum 130 rotatably installed inside the cabinet 110 in order to accommodate laundry therein; a base 120 installed below the drying drum 130, and hosting a condenser 400; and a drive motor 170 installed on one side of the base 120 for driving the drying drum 130.

In further detail, the front portion of the dryer 100 includes an inner cover 150 joined with the cabinet 110, a front cover 140 formed on the front portion of the inner cover 150 and constituting its exterior, and a door 160 installed in the approximate center of the front cover 140 to open and close. Furthermore, a cover plate 300 is installed at the rear of the inner cover 150, and a lamp and a lamp cover 200 are installed at the rear of the cover plate 300. Specifically, the lamp is protected by the lamp cover 200. Also, a door lint filter 161, for filtering lint in a preliminary stage from the circulating air that is expelled from the drying drum, is formed on the rear portion of the door 160. In addition, an exhaust port 114, for circulating the air that passes from the drying drum through the condenser 400 back into the drying drum, is formed on the area of the cabinet 110 on which the condenser 400 is located.

Furthermore, the dryer 100 includes a cooling fan 180, a drying fan 181, a drying duct 113, and a heater 190. The cooling fan 180 is rotatably connected to a motor shaft 171 of the drive motor 170 for suctioning air from outside. The drying fan 181 is connected on the opposite end of the cooling fan 180, for suctioning air from inside the drying drum 130 and circulating it inside the dryer. The drying duct 113 is installed at the rear of the cabinet 110, and redirects the circulating air that was suctioned from the drum by the drying fan 181 back into the drying drum 130. The heater 190 is installed inside the drying duct 113, and heats the circulating air (A) suctioned by the drying fan 118. Moreover, a belt 131, looping around the drive motor shaft 171 and the outer circumference of the drying drum 130, transfers the driving force from the drive motor 170 to the drying drum 130, enabling the latter to spin.

Also, the front cover 140 and the inner cover 150 define a cavity portion 115 for putting laundry into and taking laundry out of the drying drum 130. Formed at the lower portion of the front. cover 140 at the cavity portion is a body lint filter 141 for filtering lint in a secondary stage from the circulating air after it passes through the door lint filter 161. A circulation vent 142, for leading the circulating air that passes through the body lint filter 141 to the condenser 400, is formed in the base 120. Formed at the top of the front cover 140 is a control panel 112 having various control buttons and a display, and at the bottom of the front cover 140 is a grill portion 143 that allows the cooling fan 180 to suction outside air (B) into the dryer.

The following is an explanation of the operation of the above embodiment of the present invention.

First, a user opens the door 160, and shuts the door after putting wet laundry into the drying drum 130. Then, using the control buttons on the control panel 112, the user selects a drying cycle and presses the start button. At that point, the dryer 100 powers on, and the drive motor 170 and the heater 190 operate.

In detail, when the driver motor 170 operates, the belt 131 looped around the drying drum 130 rotates, causing the drying drum 130 to also rotate. The spinning of the motor shaft 171 causes the cooling fan 180 and the drying fan 181 to also spin. By spinning, the drying fan 181 circulates air inside the drying drum 130.

In further detail, the drying fan 181 causes the circulating air (A) to pass through the drying duct 113. While passing through the drying duct 113, the air (A) is heated to a high temperature by the heater 190 therein. The heated circulating air (A) then enters the drying drum 130. The circulating air (A) absorbs moisture from the wet laundry inside the drying drum 130.

The circulating air (A) that has been heated and humidified in the drying drum 130 passes through the door lint filter 161 in a preliminary lint filtering stage. The circulating air (A) then passes through the body lint filter 141 in a secondary lint filtering stage, and passes through the circulation vent 142 to reach the condenser 400 installed in the base 120. Here, the cooling fan 180 suctions outside air (B) through the grill portion 143 into the base 120 and the condenser 400, where the outside air (B) meets the circulating air (A) to exchange heat therebetween. Here, the circulating air (A) and the outside air (B) that enter the condenser 400 do not mix, and only exchange heat. Then the circulating air (A) leaves the condenser 400, and passes through the duct toward the drying fan 181. The outside air (B) leaves the condenser 400, and is expelled back to the outside through the exhaust port 114.

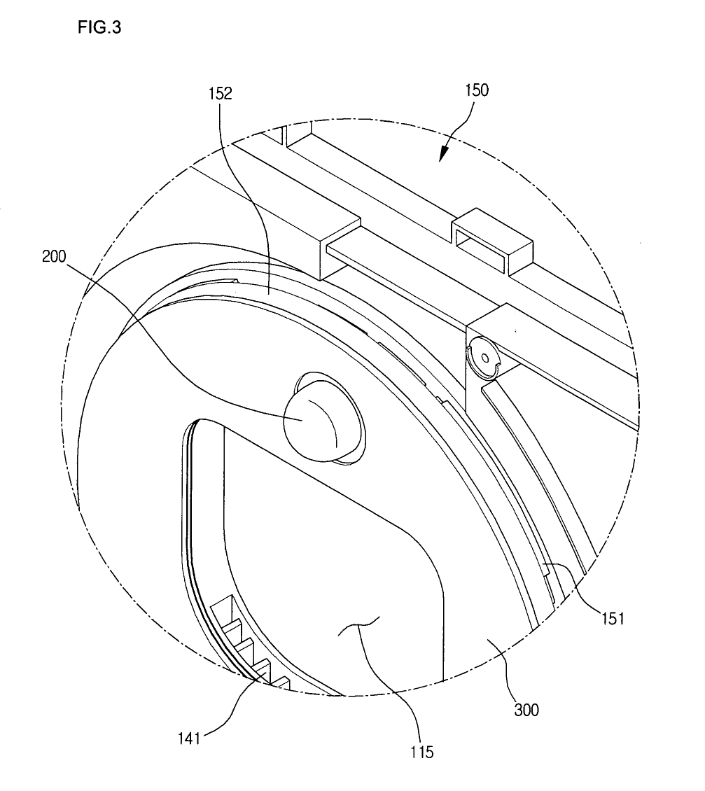

FIG. 3 is a perspective view of the inside of section C in FIG. 1.

Referring to FIG. 3, the front portion of the dryer 100 having the dryer lamp cover mount of the present invention includes an inner cover 150 installed at the front of the cabinet 110, a cover plate installed at the rear of the inner cover 150, a front cover 140 installed at the front of the inner cover 150, a door 160 installed at the front of the front cover 140, a lamp and lamp cover 200 installed at the rear of the cover plate 300, and a control panel 112 located on the top portion of the front cover 140.

The centers of the front cover 140, the inner cover 150, and the cover plate 300 define a cavity 115 through which laundry can be put into and taken out from the drum 130. In further detail, at the rear of the inner cover 150, the outer circumference of the opening at the front of the drying drum 130 is almost the same as the circumference of the drum supporting member 152. Also, the cover plate 300 is attached to the drum supporting member 152. The drum supporting member 152 intrudes into the drying drum 130. That is, the inside circumference of the opening at the front of the drum 130 can fit over the outer circumference of the drum supporting member 152. Moreover, the size of the cavity portion 115 is smaller than that of the front of the drying drum 130. The lamp cover 200 is attached to the rear of the drum supporting member 152 that intrudes into the drying drum 130, and the lamp illuminates the interior of the drying drum 130. More specifically, the lamp cover 200 is attached to the rear of the drum supporting member 152 that intrudes into the drying drum 130 at the upper part of the cavity portion 115.

Furthermore, encircling the outer surface of the drum supporting member 152 is an anti-friction bearing 151. Due to the anti-friction bearing 151, when the drying drum 130 rotates, the frictional heat that can be produced between the inner surface of the drying drum 130 and the outer surface of the drum supporting member 152 is drastically reduced. Also, the body lint filter 141 is installed at the lower part of the cavity portion 115 to allow circulating air to leave the drying drum 130.

According to the same embodiment, before the inner portion of the front opening of the drying drum 130 is installed over the outer portion of the drum supporting member 152, the lamp cover 200 is installed. In other words, after the lamp cover 200 is installed on the cover plate 300, the front portion of the drying drum 130 is installed over the drum supporting section 152. A home is formed at the rear of the cover plate 300 to accommodate the lamp, and a home is formed for attaching the lamp cover 200 thereto.

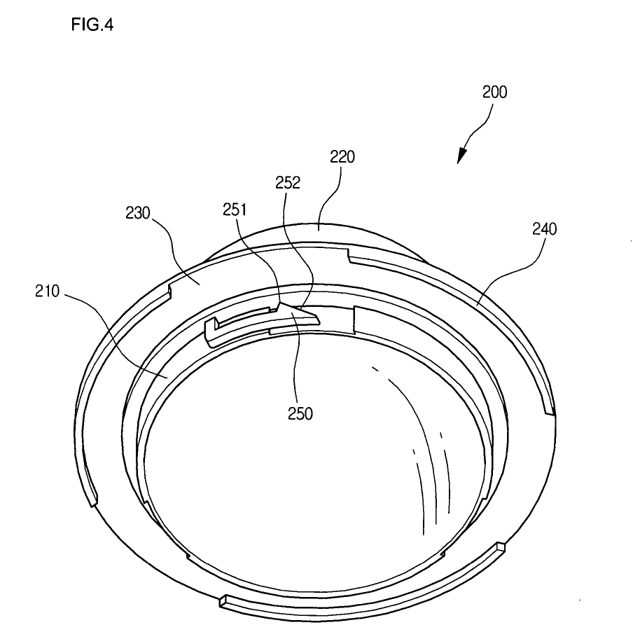

FIG. 4 is a perspective view of a lamp cover according to an embodiment of the present invention.

Referring to FIG. 4, the lamp cover 200 of the present invention, in order to radiate light emitted by the lamp throughout the interior of the drying drum 130, is made of a transparent or semi-transparent material. More specifically, by selecting an appropriate hue or transparency for the lamp cover 200, eyestrain on a user, caused by the light inside the drying drum 130, can be averted. Also, in order to control the brightness of the light emitted by the lamp, the lamp cover 200 may be made of a molded plastic with a specific color.

In order to safely house the lamp, the lamp cover 200 includes: a cover dome 220 formed in the shape of a convex dome, a sealing flange 230 radially extending for a predetermined distance outward from the base portion of the cover dome 220 to secure a seal at its bottom, and an enclosing rim 240 extending downward from the outer edge of the sealing flange 230.

In further detail, the enclosing rim 240 is formed along the sealing flange 230 for a predetermined circumferential length, preventing the seal from disengaging from the sealing flange. Also, the enclosing rim 240 can extend downward from the outer edge of the sealing flange 230 in a continuous rim or be a plurality of separate rims separated by predetermined intervals therebetween.

The lamp cover 200 further includes a cylindrical sleeve 210 extending for a predetermined length from the inner circumference of the sealing flange 230 and a plurality of a catch 250 formed on the outer circumference of the sleeve 210. The catch 250 prevents the lamp cover 200 from disengaging from the cover plate 300.

As illustrated, the catch 250 has a pointed end, from which a tapered surface 252 inclines at a predetermined angle as it moves towards the other end, and a protruding portion 251 being the highest point of the tapered surface 252. The lamp cover 200 is inserted, then rotatingly installed on the cover plate 300; and as the lamp cover 200 is rotated, the tapered surface 252 causes the cover plate 300 and the base of the lamp cover 200 to come into close contact with one another. As the lamp cover 200 comes into closer contact with the cover plate 300, the seal on the sealing flange 230 presses firmly against the cover plate 300. As a result, the seal prevents moisture from seeping into the lamp cover 200 and causing an electrical failure in the lamp.

The following is a detailed explanation of the assembling process of the lamp cover 200 and the cover plate 300.

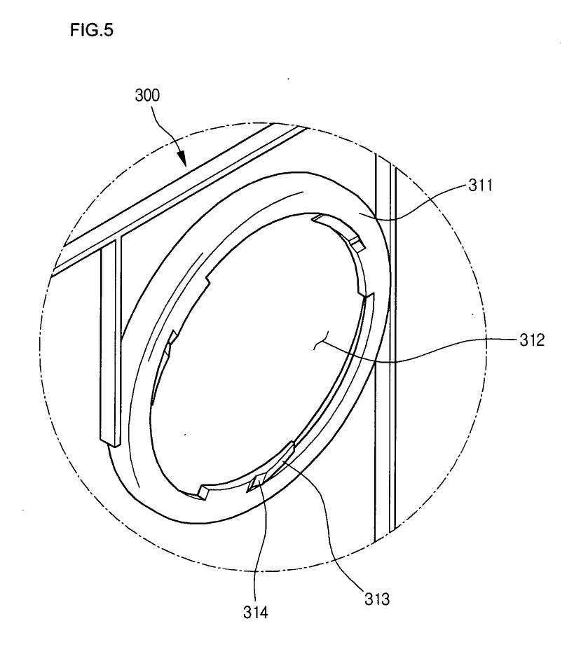

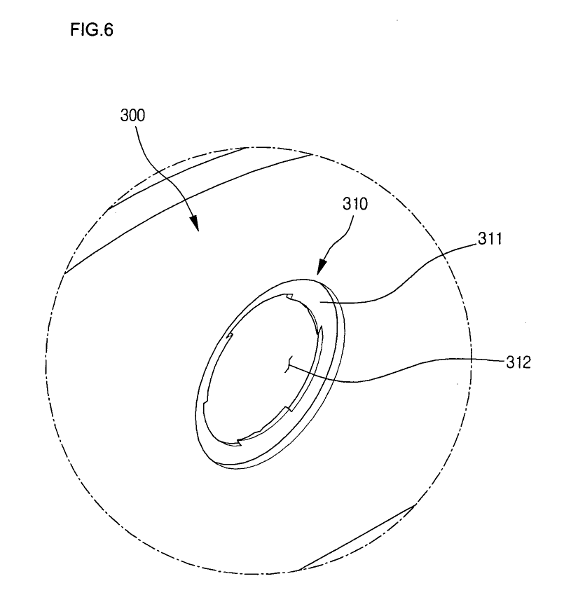

FIG. 5 is an enlarged frontal perspective view of a cover plate on which the mount for the lamp cover is formed according to an embodiment of the present invention, and FIG. 6 is an enlarged rear perspective view of the cover plate in FIG. 5.

Referring to FIGS. 5 and 6, the lamp cover 200 of the present invention mounts on the cover plate 300.

In further detail, the cover plate 300 defines a cavity portion 115 (refer to FIG. 3) of a predetermined size, and a lamp cover mount is attached to the upper part of the cavity portion 115. The lamp cover 200 is attached to the rear of the cover plate 300.

In addition, a lamp cover mount 310 for mounting the lamp cover 200 includes: a sealing receiving surface 311 that passes through the cover plate 300 in a predetermined diameter and depth; a lamp receptacle 312 for receiving a lamp, having a predetermined diameter formed inside the sealing receiving surface 311; and a catch receptacle formed radially along and projecting inward from the inner circumference of the lamp receptacle 312, the catch receptacle having a tapered portion 313 tapered circumferentially inward at a predetermined angle and a depressed portion 314 depressed at a predetermined depth directly after the tapered portion 313.

In further detail, the tapered portion 313 is tapered at an angle complementary to that of the tapered surface 252 of the catch 250, allowing the catch 250 to slide along the tapered portion 313. That is to say, when the lamp cover 200 is inserted in the lamp cover mount 310 and rotated, the tapered surface 252 will ride up on the tapered portion 313. Then the protruding portion 251 of the catch 250 is caught by the depressed portion 314, preventing unprovoked disengagement of the lamp cover 200 from the cover plate 300, once they have been assembled. Consequently, the shape of the depressed portion 314 may complement that of the protruding portion 251.

The following explains the completion of the lamp cover 200 assembly.

First, the lamp cover 200 is positioned so that the enclosing rim 240 formed on the sealing flange 230 of the lamp cover 200 completely overhangs the receiving surface 311 of the lamp cover mount 310. Then, the lamp cover 200 is rotated either clockwise or counterclockwise.

When the lamp cover 200 is rotated, the tapered surface 252 formed on the catch 250 slides along the tapered portion 313. The lamp cover 200 is rotated until the protruding portion 251 of the catch 250 is caught by the depressed portion 314. When the lamp cover 200 is rotated, it is brought closer to the cover plate 300 by the angles of the tapered surface 252 and the tapered portion 313. Also, the seal inside the lamp cover 200 presses firmly against the receiving surface 311 of the cover plate 300, preventing moisture inside the drying drum 130 from seeping into the lamp.

It will be apparent to those skilled in the art that various modifications and variations can be made in the present invention. Thus, it is intended that the present invention covers the modifications and variations of this invention provided they come within the scope of the appended claims and their equivalents.

1. A lamp cover mounting structure for a dryer, comprising:
a drying drum;
a supporting member for supporting a front portion of the drying drum;
a lamp cover installed on a rear portion of the supporting member; and
a lamp cover mount formed on the rear portion of the supporting member for installing the lamp cover thereon.

2. The lamp cover mounting structure according to claim 1, wherein the lamp cover includes a seal resting therein.

3. The lamp cover mounting structure according to claim 1, wherein the lamp cover is made of a transparent or semi-transparent material.

4. The lamp cover mounting structure according to claim 1, wherein the supporting member includes:
a drum supporting portion protruding a predetermined length rearward to support the front portion of the drying drum; and
a cover plate installed at an end of the drum supporting portion and having the mount formed on an upper portion thereof.

5. The lamp cover mounting structure according to claim 1, wherein the mount includes:
a receiving surface recessed at a predetermined depth for receiving the lamp cover; and
a lamp receptacle formed inside the lamp cover receiving surface for receiving a lamp.

6. The lamp cover mounting structure according to claim 5, wherein the lamp cover receiving surface is recessed at a predetermined depth from the rear toward the front of the supporting portion.

7. The lamp cover mounting structure according to claim 1, wherein the lamp cover includes:
a cover dome for receiving a lamp;
a sleeve extending from a base of the cover dome for inserting into the mount; and
a catch formed on the outer circumference of the sleeve for preventing the lamp cover from disengaging from the mount.

8. The lamp cover mounting structure according to claim 7, wherein the catch has one end tapered to a point.

9. The lamp cover mounting structure according to claim 7, wherein the mount includes:
a sliding portion on the surface of the mount on which the lamp cover is mounted, allowing the catch to slide therealong; and
a recessed portion for receiving a highest inclined point of the catch.

10. The lamp cover mounting structure according to claim 7, wherein the lamp cover includes:
a sealing flange radially projecting a predetermined distance from a base of the cover dome to receive a seal; and
an enclosing rim bent from an outer circumference of the sealing flange for preventing the disengaging of the seal from the sealing flange.

11. A lamp cover mounting structure for a dryer, comprising:
a lamp cover disposed at a front of a drying drum, the lamp cover including a lamp receptacle for receiving a lamp inside, an flange extending from a base of the lamp receptacle, a cylindrical sleeve extending from the base of an inner circumference of the lamp receptacle, and a catch formed on an outer circumference of the sleeve;
a cover plate for attaching the lamp cover to its rear surface, the cover plate including a lamp cover mount being recessed at a predetermined depth for the flange to fit into, a lamp receptacle defined by an inner portion of the mount to receive the sleeve, and a catch receptacle formed on the mount for receiving the catch; and
a front cover attached to a front of the cover plate for supporting the front portion of the drying drum.

12. The lamp cover mounting structure according to claim 11, wherein the lamp cover is attached to a top portion of the cover plate.

13. The lamp cover mounting structure according to claim 11, further comprising:
a seal in an inner portion of the flange; and
an enclosing rim extending from the circumference of the flange for preventing the disengaging of the seal.

14. The lamp cover mounting structure according to claim 11, wherein the lamp receptacle has a dome of a predetermined curvature formed thereon.

15. The lamp cover mounting structure according to claim 11, wherein the outer circumference of the sleeve has at least two catches formed thereon with a predetermined distance therebetween.

16. The lamp cover mounting structure according to claim 11, wherein the catch has an end tapered at a predetermined angle for allowing the lamp cover to attach firmly to the mount when rotated thereon.

17. The lamp cover mounting structure according to claim 11, wherein the catch receptacle includes:
a tapered portion tapered at approximately the same angle as the corresponding portion of the catch; and
a depressed portion immediately after the incline of the catch, recessing in the same manner as the corresponding portion of the catch.

18. The lamp cover mounting structure according to claim 11, wherein the lamp cover, in order to adjust brightness of light from the lamp, is made of a transparent or semitransparent plastic material.

19. The lamp cover mounting structure according to claim 11, wherein the lamp cover, in order to adjust brightness of light from the lamp, is of a specific hue.

20. A dryer comprising:
a drying drum;
a front cover supporting a front of the drying drum;
a cover plate attached to a rear of the front cover;
a lamp cover installed on one side of the cover plate, having a coupling catch formed on an outer circumference, for solidly coupling the lamp cover to the cover plate; and
a lamp inside the lamp cover.
